(19) United States
(12) Patent Application Publication
(10) Pub. No.: US 2008/0132625 A1
(43) Pub. Date: Jun. 5, 2008

(54) Perfumed Melt Adhesive

(76) Inventors: Erik Niehaus, Neuss (DE); Petra Padurschel, Duesseldorf (DE); Marcel Roth, Duesseldorf (DE); Gunter Hoffmann, Bopfingen (DE); Rolf Tenhaef, Duesseldorf (DE); Georg Meine, Mettmann (DE); Andreas Bauer, Kaarst (DE)

Correspondence Address: HENKEL CORPORATION, 1001 TROUT BROOK CROSSING, ROCKY HILL, CT, 06067, US

(21) Appl. No.: 11/964,750

(22) Filed: Dec. 27, 2007

Related U.S. Application Data
(63) Continuation of application No. PCT/EP2006/004828, filed on May 20, 2006.

(30) Foreign Application Priority Data
Jun. 30, 2005 (DE) 10 2005 030 431.1

(51) Int. Cl. C08K 5/04; C08K 5/05; C08K 5/06; C08K 5/07; C08K 5/09; C08K 5/10

(52) U.S. Cl. 524/285; 524/355; 524/359; 524/366; 524/384; 524/1; 524/556; 524/570; 524/606; 524/599; 524/612

(57) ABSTRACT

A hot melt adhesive that contains fragrances is provided. The hot melt adhesive can be used to adhere packaging materials to one another and, upon exposure of the adhesive surface, releases a fragrance, in particular at low temperatures. A method for manufacturing such a hot melt adhesive is also provided, wherein the thermal stress from manufacture is kept low.

### CROSS-REFERENCE TO RELATED APPLICATIONS

This application is a continuation under 35 U.S.C. § 365(c) and 35 U.S.C. § 120 of international application PCT/EP2006/004828, filed 20 May 2006, and published 24 May 2007 as WO 2007/057059, which is incorporated herein by reference in its entirety. This application also claims priority under 35 U.S.C. § 119 of DE 10 2005 030 431.1, filed 30 Jun. 2005, which is incorporated herein by reference in its entirety.

### FIELD OF THE INVENTION

The present invention relates to a hot melt adhesive that contains fragrances. The intention is in particular to make available hot melt adhesives that adhere packaging materials to one another and, upon exposure of the adhesive surface, release a fragrance, in particular also at low temperatures. The invention further relates to a method for manufacturing said hot melt adhesives, the thermal stress from manufacture being kept low.

### DISCUSSION OF THE RELATED ART

Hot melt adhesives are commonly known. They serve, inter alia, to adhesively bond packages for foods, e.g., paper packages, cans, or containers. Hot melt adhesives that also adhere textiles or fiber materials to one another are additionally known.

Hot melt adhesives that contain fragrances are already known. They are described, for example, in WO 03/048264, which describes hot melt adhesives that contain fragrant materials having a flash point >100° F. These are manufactured by stirring hot melt adhesives together with a corresponding fragrance. Protective actions upon incorporation are not required. The application described is use in diapers or other sanitary articles.

Foods and other commodities are often packaged in tear-open packages made, for example, of paper or plastics. Foods often have a characteristic odor; other commodities are intended to smell pleasant. Volatile fragrances can be used in the packaging in order to impart to the purchaser, at the time the package is purchased or opened, a positive perception of the contents. Introduction into the food is, however, usually undesirable. Application to the entire outer surface of the package usually means, however, that the fragrances are already lost during storage.

One possibility for immobilizing fragrances is therefore to add fragrances to adherent substances such as hot melt adhesives, and apply them in controlled fashion onto the package. Fragrances are then released at those locations. Any desired packages or other objects can thus be provided with slow-release fragrances. Hot melt adhesives for the food sector conform to meet specific requirements. In addition, they must meet visual requirements, i.e., the adhesives are to be substantially clear or white in color.

It is additionally necessary, especially when adding fragrances that are volatile at low temperature, to take appropriate measures during manufacture to prevent any odor impact. This can involve simply an odor impact, but can also result in health hazards, e.g., allergies. Polymers or fragrances must also be prevented from breaking down as a result of thermal stress. This problem requires attention in particular during manufacture, since this is when the corresponding raw materials are processed at increased concentration or in increased quantities.

### BRIEF SUMMARY OF THE INVENTION

The object of the present invention is therefore to make available a hot melt adhesive that permits a controlled release of fragrances/aroma chemicals. This release is intended to occur upon exposure of the bonded surface of the substrates; this can also take place even at lower temperatures. A further object of the invention is to make available a method with which such fragrances can be incorporated in low-impact fashion into hot melt adhesives.

The object is achieved by a hot melt adhesive based on 10 to 75 wt % of a hot melt adhesive base polymer, 10 to 70 wt % of a tackifying resin, 0 to 50 wt % of a plasticizer and/or wax, 0 to 15 wt % additives, and 0.01 to 10 wt % of at least one fragrance having a c Log P value between 1.0 and 20. The sum of the constituents is to equal 100%.

A further subject of the invention is a method for manufacturing the hot melt adhesives according to the present invention by continuous manufacturing in an extruder, the fragrance preferably being incorporated in a late stage of the process. A further subject of the invention is a package adhesively bonded with such a hot melt adhesive, which package exposes the bonded surface upon opening and thereby releases the fragrance.

### DETAILED DESCRIPTION OF CERTAIN EMBODIMENTS OF THE INVENTION

“Hot melt adhesive base polymers” are understood as thermoplastic synthetic polymers that substantially determine the properties—such as adhesion, strength, and temperature behavior—that are important for hot melt adhesives. Examples of such polymers are polyamide resins, copolyamides, polyether amides, polyester amides, polyesters, polyethers, polycarbonates; thermoplastic elastomers; reactive and nonreactive linear or branched thermoplastic polyurethanes; polymerizates such as ethylene-vinyl acetate, ethylene, ethylene-acrylate, propylene-hexene, SIS, SBS, and SEBS copolymers; polyolefins such as amorphous polyolefins, semicrystalline polyolefins, in particular propylene or ethylene homo- or copolymers.

In the compositions according to the present invention, the hot melt adhesive contains at least one base polymer having a molecular weight from 2000 to 200,000 g/mol. Molecular weight indications are intended to indicate the arithmetic mean of the molecular weight, as obtainable by gel permeation chromatography. Such polymers are already known to the skilled artisan. Polymers based on propylene-styrene and/or ethylene-styrene copolymers, acrylate copolymers, ethylene-vinyl acetate copolymers, amorphous polypropylenes, or other semicrystalline olefin copolymers are used by preference in the hot melt adhesives according to the present invention.

Base polymers suitable for use in hot melt adhesives are polyacrylates. Polyacrylates of this kind are obtainable, for example, by polymerization or copolymerization of ethylenically unsaturated carboxylic acid esters such as acrylic acid, methacrylic acid, crotonic acid, or maleic acid esters. Usual C₁ to C₁₅ alkyl esters of (meth)acrylic acid are preferably polymerized. Monomers carrying OH groups can also be contained. Such monomers are obtainable, for example, by esterifying ethylenically unsaturated carboxylic acids and difunctional alcohols. Corresponding unsaturated esters carrying OH groups are, for example, 2-hydroxyethyl (meth)acrylate, 2-hydroxypropyl (meth)acrylate, 3-hydroxypropyl (meth)acrylate, or mixtures thereof. Functionalized or non-functionalized polymers can be obtained Ethylene, for example, can also be copolymerized if applicable. Binders of this kind are commercially obtainable.

Known ethylene-vinyl acetate (EVA) copolymers can also be selected as base polymers. The manufacture and composition of such EVAs, optionally with further comonomers, are known to the skilled artisan, for example under the trade names ALCUDIA EVA or ESCORENE.

In a preferred embodiment, atactic poly-α-olefins are selected as a base polymer. These can have, for example, a molecular weight from more than 4000 g/mol to 200,000 g/mol, and can be made up of the monomers ethylene, propylene, and/or further comonomers, such as styrene derivatives, diolefins, or C₄ to C₂₀ α-olefins; terpolymers, in particular, are also suitable. In order to improve adhesion on usual substrates, largely amorphous poly-α-olefins (APAO) of this kind can carry functional groups, in which case comonomers having functional groups are then used, e.g. acrylic acid, maleic acid, or vinyl acetate. These functional groups can be introduced either by copolymerization with small quantities of functional monomers, or preferably by subsequent radical reaction of APAOs with functional monomers of this kind. Functionalized monomers of this kind are usually introduced in quantities from 0.1 to 10 wt %. The softening temperatures of the largely amorphous poly-α-olefins are usually above 100° C. (ring and ball method per ASTM E 28). These APAOs are known to the skilled artisan, and suitable polymers or mixtures can be selected therefrom. They are obtainable, for example, under the commercial designation VESTOPLAST.

Portions of largely crystalline poly-α-olefins can also additionally be used. The degree of crystallization in this context is usually >55% (determined by differential calorimetry, DSC). The largely crystalline poly-α-olefins are manufacturable as isotactic polymers using Ziegler-Nafta catalysts. Polyethylene, polypropylene, polybutylene, or polystyrene, or copolymers, are generally used; by preference, isotactic polypropylene copolymers having a molecular weight of more than 5000 g/mol are used.

A particularly preferred embodiment of the present invention works with polyolefins manufactured by metallocene catalysis as base polymers. These are largely linear copolymers of at least two monomers based on ethylene and/or propylene with, if applicable, a further C₄ to C₂₀ α-olefin comonomer, the copolymer having a M_{N} from 2000 to 100,000 g/mol and a density between 0.85 and 0.96 g/cm³. These can be atactic, isotactic, or syndiotactic polymers. Preferably these are copolymers that contain a propylene concentration of more than 80 mol %, or an ethylene concentration above 75 mol %. It is likewise possible to modify these polymers, for example as already described above, by grafting with functional monomers, by oxidation, or by polymerizing in aromatic-group-containing monomers. A graft reaction with aromatic-group-containing monomers, such as styrene or its derivatives, is particularly suitable.

These preferred polyolefin copolymers have a low polydispersity index M_{W}:M_{N} of less than 3, in particular <2.5. The molecular weight of these polymers should be, in particular, less than 40,000 g/mol, in particular between 3000 and 25,000 g/mol. Mixtures of polymers having different molecular weights can also be used. Such polymers are commercially available, e.g. under the trade name LICOCENE or AFFINITY.

Selection of the base polymers is an easy matter for one skilled in the art. The polymers (and their properties) are known, and can be selected as a function of the intended use, e.g., spray application, for thermally sensitive substrates, fast setting times, particular substrate adhesion. A single base polymer can be used, but mixtures of preferably two or more polymers can also be used. The quantity is intended to be 10 to 75 wt %, preferably 20 to 65 wt %, based on the hot melt adhesive.

As a further component, the hot melt adhesive according to the present invention contains at least one tackifying resin. The resin brings about additional tackiness, and improves the compatibility of the hot melt adhesive components. These resins are, in particular, those that possess a softening point from 70 to 150° C. These are, for example, aromatic, aliphatic, or cycloaliphatic hydrocarbon resins, as well as modified or hydrogenated versions thereof. Examples thereof are aliphatic or alicyclic petroleum hydrocarbon resins and hydrogenated derivatives. Further resins usable in the context of the invention are colophon and derivatives, such as colophon esters, in particular its esters with pentaerythritol or glycerol; preferably modified natural resins such as resin acids from balsam resin, tall rosin, or wood rosin, for example fully saponified balsam resin, or alkyl esters of (optionally) partially hydrogenated colophon having low softening points; terpene resins, in particular copolymers of terpene, such as styrene/terpene, α-methyl styrene/terpene, phenol-modified terpene resins, and hydrogenated derivatives thereof; acrylic acid copolymers, by preference styrene-acrylic acid copolymers, and reaction products based on functional hydrocarbon resins. It is preferred to use hydrogenated hydrocarbon resins or colophon esters, individually or mixed.

The tackifying resin has a low molecular weight of less than 3000 g/mol, in particular less than 1500 g/mol. It can be chemically nonreactive or it can, if applicable, also contain functional groups such as, for example, OH groups, carboxyl groups, or double bonds. The quantity of resin is usually between 10 and 70 wt %, preferably between 10 and 50 wt %.

If applicable, waxes can be added to the hot melt adhesive, in quantities from 0 to 50 wt %, preferably 5 to approximately 30 wt %. These can also influence the viscosity of the hot melt adhesive. The quantity is, in this context, such that on the one hand the viscosity is lowered into the desired range, but adhesion is not negatively influenced. The wax can be of natural origin, if applicable also in chemically modified form, or of synthetic origin. Plant waxes, animal waxes, or petrochemical waxes can be used as natural waxes. Hard waxes such as montan ester waxes, sasol waxes, mineral waxes, etc. can be used as chemically modified waxes. Polyalkylene waxes and polyethylene glycol waxes can be utilized as synthetic waxes. By preference, petrochemical waxes such as petrolatum, paraffin waxes, and synthetic waxes are used, in particular polyethylene waxes having a molecular weight from 500 to 2000 g/mol, paraffin waxes, microcrystalline waxes, or synthetic Fischer-Tropsch waxes that have melting points in the range from 50 to 140° C.

A further constituent of the hot melt adhesive according to the present invention can be plasticizers. These plasticizers are used by preference to adjust the viscosity or flexibility, and are generally contained at a concentration from 0 to 25 wt %, by preference from 2 to 15 wt %. Suitable plasticizers are, for example, medicinal white mineral oils, naphthenic mineral oils, oligomers of polypropylene, polybutene, and polyisoprene, hydrogenated polyisoprene and/or polybutadiene oligomers, benzoate esters, phthalates, adipates, vegetable or animal oils, and derivatives thereof. Hydrogenated plasticizers are selected, for example, from the group of the paraffinic hydrocarbons. Polypropylene glycol, polybutylene glycol, or polymethylene glycol are also suitable. If applicable, esters are also used as plasticizers, for example liquid polyesters and glycerol esters, or plasticizers based on aromatic dicarboxylic acid esters. Alkyl monoamines and fatty acids having, by preference, 8 to 36 carbon atoms can likewise be suitable.

Further additives can be incorporated into the hot melt adhesive in quantities of up to 15 wt % in order to vary certain properties. These can be, for example, dyes, pigments, or fillers such as titanium dioxide, talcum, clay, chalk, and the like. They can also, for example, be stabilizers or adhesion promoters.

The purpose of the stabilizers is to protect the adhesive composition from breakdown during processing. Particularly to be mentioned here are the antioxidants, as well as light protection agents. They are usually added to the hot melt adhesive in quantities of up to 3 wt %, by preference in quantities from approximately 0.1 to 1.0 wt %.

The hot melt adhesive according to the present invention can furthermore contain adhesion promoters. Adhesion promoters are substances that improve adhesion of the hot melt adhesive to the substrate being bonded. Adhesion promoters are intended in particular to improve the aging behavior of adhesive bonds under the influence of a humid atmosphere. Typical adhesion promoters are, for example, ethylene-acrylamide comonomers, polymeric isocyanates, reactive organosilicon compounds, or phosphorus derivatives. These can also influence the adhesive's wetting properties, and thus its ability to adhere to substrates.

The additives, such as pigments, dyes, stabilizers, or adhesion promoters, are known to the skilled artisan. They are commercial products, and the skilled artisan can select them in accordance with the properties desired. Care must be taken in this context that compatibility with the polymer mixture exists.

The hot melt adhesive according to the present invention must contain at least one fragrance. “Fragrances” are to be understood in this connection as all substances such as fragrances, odorants, aroma chemicals, or perfume oils. These can be individual substances, but are usually mixtures of several substances. These together yield the fragrance note. This fragrance note can be selected and assembled by the skilled artisan. According to the present invention, it is necessary that the fragrances possess a certain polarity. What can thereby be achieved is on the one hand that the fragrance can be incorporated in shelf-stable fashion into the hot melt adhesive and does not interfere with adhesion to the substrate, but that controlled release to the ambient air is still enabled. The polarity for fragrances is often indicated as the n-octanol/water partition coefficient (P). This value reflects the partition ratio, at equilibrium concentration, of the dissolved fragrance between two phases. The base-10 logarithmic values (log P) are indicated. These log P values are provided in the literature for many fragrances. It is also possible to calculate such values (c Log P). Calculation methods of this kind are indicated, for example, in “Comprehensive Medicinal Chemistry vol. 4, page 295.” The values indicated can be determined experimentally or they can be calculated. These values are collectively referred to here as c Log P values. The numerical value provides an indication of the hydrophilic/hydrophobic properties of the fragrance.

According to the present invention, the c Log P value for suitable fragrances is to be between 1.0 and 20, preferably between 1.2 and 10.0, in particular up to approximately 5.0. Such fragrances can easily be incorporated into the polymers of the hot melt adhesive according to the present invention. Assurance also exists that they are discharged out of an applied adhesive top layer into the ambient air. Because mixtures of fragrances are generally used, at least 80 wt % of the components of the active fragrance, i.e., without any possible carrier substance or solvent, is intended to exhibit a corresponding c Log P value.

A further indication for characterizing fragrances is provided by the volatility of the odor (substantivity), which is also referred to as the fragrance note.

This classification into fragrance notes is often described in the context of commercial fragrance components.

Fragrances usually comprise three fragrance note parts, such as the top note, preferably made up of volatile constituents that produce the first odor impression; the middle note, which yields a more lasting impression and persists longer; and the base note, which encompasses the less-volatile fragrance impressions that persist over the long term. According to the present invention, the fragrance is made up predominantly of substances that can be assigned to the middle or base note. Constituents that adhere over the long term, such as the middle or base note, are intended to be present in sufficient quantity, generally above 50 wt %. By selecting fragrances having a predominant proportion of middle or base notes, and by way of a selected c Log P value for the individual fragrances, it is possible to incorporate the fragrances homogeneously into the adhesives according to the present invention and to ensure release over a period of approximately three hours.

The fragrances can be natural substances such as essences from fruit parts, plant parts, or essential oils recovered therefrom, or can be synthetic odor compounds or fragrances. The synthetic products can be identical to the natural fragrances, such as, for example, vanillin, menthol, eucalyptol, or can be artificial products. These fragrances can be derivatives of hydrocarbons, heterocycles, alcohols, aldehydes, ketones, acetals, esters, phenols, phenol ethers, or thiols. They can be individual compounds, but mixtures of several substances are often necessary. Examples of essential oils are anise oil, bitter almond oil, fennel oil, citrus oil, jasmine oil, rose oil, chamomile oil, clove oil, mint oil, cinnamon leaf oil, orange blossom oil, oil of bergamot, eucalyptus oil, fir needle oil, guaiac wood oil, ginger oil, iris oil, cajeput oil, cardamom oil, coriander oil, lavender oil, lime oil, tangerine oil, or lemon balm oil; synthetic odorant compounds are, for example, esters such as benzyl acetate, phenoxyethyl isobutyrate, p-tert.-butycyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate, and benzyl salicylate; ketones or aldehydes such as alkanals having 8 to 18 carbon atoms, citral, citronellal, citronellyl oxyacetaldehyde, cyclamenaldehyde, hydroxycitronellal, lilial, and bourgeonal; ketones such as ionone, isomethyl ionone, and methyl cedryl ketone; hydrocarbons such as limonene and pinene; alcohols such as cinnamon alcohol, anise alcohol, vanillin, eugenol, thymol, farnesol, borneol, anethol, citronellol, geraniol, linalool, and phenylethyl alcohol; or ethers such as benzylethyl ether and ambroxan. The list does not represent a conclusive enumeration, but is intended merely to indicate examples of various substance classes.

More-volatile fragrances are odorants of this kind, of natural or synthetic origin, that evoke a rapid olfactory impression. These can also be, in particular, low-boiling-point odorants that can be used alone or in mixtures.

The fragrance that is suitable according to the present invention must be volatile. The molecular weight is generally between 100 g/mol and 300 g/mol. More-volatile fragrances are particularly preferred in the context of the invention. The fragrances can be liquid, pasty, or solid fragrances.

The fragrances can be used as a pure substance. They can be used as a solution in organic solvents or in water. Solvents used are, for example, alcohols such as glycerol, ethylene glycol, propylene glycol, diethylene or dipropylene glycol, etc. They can also be used on carrier materials such as waxes, paraffins, etc. It is likewise possible to embed them into cluster compounds such as, for example, cyclodextrin/fragrance complexes.

The quantity of fragrances is intended to be 0.01 to 10 wt %, preferably 0.05 to 5 wt %, in particular 0.1 to 3 wt %. If applicable, inert substances can additionally be mixed into the fragrance. These can nevertheless, if applicable, enhance the olfactory action of the fragrance. The fragrances present according to the present invention are by preference intended to be present in homogeneously distributed fashion in the hot melt adhesive.

The hot melt adhesive according to the present invention is intended to have a viscosity between 100 and 15,000 mPas at 120° C. to 180° C., preferably below 7500 mPas at up to 150° C. (measured with Brookfield RVT, no. 27 spindle, per EN ISO 2555).

The hot melt adhesives according to the present invention can be usual hot melt adhesives that bring about adhesion solely on the basis of thermoplastic properties. They can also, however, be reactive hot melt adhesives such as, for example hot melt adhesives that crosslink via isocyanate groups, or permanently tacky hot melt adhesives. In the case of reactive hot melt adhesives, it must be ensured that the reactive groups of the hot melt adhesive do not react with the fragrances. In the case of permanently tacky hot melt adhesives, it is possible to bond these bonded surfaces repeatedly to the substrate.

The invention further relates to a method for manufacturing hot melt adhesives according to the present invention that contain fragrances. It is also possible in principle to produce hot melt adhesives according to the present invention by mixing the components while heating in an agitator. To decrease the thermal stress, the temperature-sensitive substances, in particular the fragrances contained according to the present invention, are to be added if at all possible at a later point in time. According to the present invention, the method is carried out in a closed system, so that substances that might evaporate can be aspirated.

A preferred embodiment, however, relates to continuous manufacture. In an embodiment, the previously mixed hot melt adhesive is introduced into the extruder. This can occur in solid or in already melted form. A further embodiment introduces all the constituents of the hot melt adhesive, individually or in premixed fashion, into the extruder. A further embodiment first introduces individual components of the hot melt adhesive, for example the base polymer or mixture of base polymers, into the extruder, and further components, such as the tackifying resin, are added in steps at a later point in time. Upon mixing and melting in the extruder, the mixtures of the polymers are heated, melted, and homogenized. In this context, the temperature is controlled and is limited to a value such that the polymers and other constituents do not experience excessive thermal stress. For example, little or no discoloration of the hot melt adhesive should be visible in the finished product. The temperature is below 180° C., generally below 150° C., preferably below 120° C., in particular below 100° C. Mixing and melting in the extruder makes possible particularly rapid and low-impact homogenization of the materials. The temperature in the extruder can be influenced by a variety of actions. For example, it is possible to heat or to cool the extruder. In addition, the temperature can be influenced or adjusted by way of the rotation speed of the extruder screws, the shear gap or pitch of the extruder screws, and the molecular weight of the polymers contained in the mixture. If said polymers are introduced as a solid, they melt only in the course of the mixing process.

The addition sequence can be selected so that the high-molecular-weight solid products are added at the beginning, and then melt; the more easily melted, low-viscosity products are then incorporated. A corresponding procedure intensifies the plastication and mixing effect of the extruder.

When a homogeneous mixture of the stable hot melt adhesive components is present, the temperature-sensitive and low-viscosity portions are introduced into the extruder. These are, for example, plasticizers, waxes, additives, such as antioxidants or adhesion promoters. The fragrances can also be metered in at this time. It is useful to limit the processing temperature at this point in time, or optionally also to lower it beforehand, for example by cooling. For example, processing even at temperatures of up to 120° C. is possible; if applicable, certain constituents, for example, the fragrances, can also be added at temperatures of up to 80° C. The mixing and transport properties of the extruder make it possible to lower the working temperature in the extruder as compared with other mixing units, and to achieve a shorter mixing time or residence time in the mixing unit. Metering in of the further components can occur in one step or also in several steps, the fragrance preferably being introduced in the last step at lower temperature.

The fragrance or fragrances can be present in solid or in liquid form. They can be metered directly into the mixture. The fragrances can furthermore also be added when they are present, for example, absorbed onto solid carrier materials. These solids, too, can be dispensed at this point in time into the mixture and are homogenized.

According to the present invention, it is possible to add one or more fragrances in concentrated form as a complete pre-mix. With small quantitative concentrations in particular, however, it is preferred, in order to facilitate metering of the quantities, to mix the fragrances and, if applicable, their carrier materials beforehand into portions of individual components of the hot melt adhesive, and then meter them. It is necessary in this context that these components not react with the fragrance mixture. For example, the fragrance can be mixed into portions of the plasticizer, e.g. in liquid form, or dissolved or dispersed fashion; but it is also possible to disperse the fragrance into portions of the wax or of the tackifying resin. These mixtures in the form of a masterbatch are then metered in proportionally, so that overall, no change occurs in the composition of the hot melt adhesive. One particular embodiment works with aqueous solutions of the fragrance components. Aqueous solutions of this kind can be used in the method according to the present invention even if the working temperature in the mixture is above 100° C., if evaporation of the small water component is prevented by the pressure inside the extruder. The result is to form homogeneous mixtures that release the water component only upon degassing of the hot melt adhesive. A mixture temperature below 100° C. can also be set for the mixture. With the procedure according to the present invention, at least partial retention of water concentrations in the hot melt adhesive can be achieved. Such hot melt adhesives are then particularly suitable for receiving polar fragrances and retaining them in the adhesive. It must be noted in this context that water can be used as a solvent only to the extent that the hot melt adhesives are nonreactive. Water must be absolutely avoided during manufacture in the case of reactive hot melt adhesives, for example isocyanate-reactive ones.

Once the hot melt adhesive components are completely mixed, the liquid or viscous hot melt adhesive is degassed if applicable, and then discharged from the extruder. This is usually done with the use of a cooling apparatus. This cooling can be performed in the extruder itself or occurs after discharge from the extruder. This can be done using cooled gases, e.g., air, or carbon dioxide, that are directed onto the hot melt adhesive. It is also known to discharge the hot melt adhesive onto a cooled substrate, e.g. a cooled panel or a cooled strip, or it is preferably discharged into a cold liquid, e.g. water. The hot melt adhesive can likewise, immediately after cooling to a suitable temperature, be subjected to pelletization or even to underwater pelletization. It is also possible to package the hot melt adhesive directly into, for example, film pouches, seal them, and then cool them. Controlling the temperature of the mixture upon discharge from the extruder to less than 120° C., in particular below 75° C., is particularly suitable for low-impact processing of the hot melt adhesives.

Apparatuses for mixing the components, for metered introduction of the components into the extruder, and for discharging and packaging the hot melt adhesives are known to the skilled artisan. These involve the usual single- or multiple-screw extruders or, preferably, also double-screw extruders. The metering devices for the fragrances are intended, in principle, not to be in direct contact with the ambient working air. It is preferred if these units are encapsulated, or if air can be aspirated therefrom. It is useful for the procedure according to the present invention if the fragrances or the fragrance-containing precursor products, as well as the high-temperature hot melt adhesive equipped with fragrances, are further processed in such a way that large quantities of the fragrance do not evaporate into the working environment. This can be ensured by way of closed equipment or with aspiration devices.

It is particularly preferred that the components of the hot melt adhesive be homogenized, and that the fragrances be metered in at a later time in the process at the lowest possible temperature. This metering can be carried out in an apparatus encapsulated from the environment. It is additionally preferred if the hot melt adhesives are introduced, immediately after extrusion, into a sealed silicone-paper or plastic casing and are then cooled and stored or, after pelletizing, packaged in a plastic casing.

The hot melt adhesives according to the present invention are used in a known manner. For example, hot melt adhesives of this kind can be applied onto packaging materials. Such materials can be made of paperboard, corrugated board, paper, imprinted paper, single- and multi-layer plastic films, metallized films, or imprinted substrates, plastics, and similar substrates. Application can be carried out using known methods, such as rolling, printing, blade-coating, roller application, spraying, or nozzle application, if applicable including with a wide-slit nozzle. Corresponding substrates and corresponding application apparatuses are known to the skilled artisan. The application temperature depends on the selection of base polymers. It can be between 80° C. and 180° C., preferably below 150° C.

In order to avoid fragrance emission while the adhesively bonded substrates are being stored, it is useful to cover the corresponding fragrance-containing adhesive. This can be done by adhesive bonding to the second substrate side, but additional cover layers, such as film strips or paper layers, can be provided. After application of the hot melt adhesive, the package is immediately bonded, i.e., the two substrate surfaces are brought together and pressed, and join to one another. Preferably, no hot melt adhesive surfaces that are open to the air or face toward the contents should be produced.

If the hot melt adhesive according to the present invention possesses a sufficient fragrance effect, one adhesively bonded surface having an adhesive according to the present invention may possibly be sufficient; i.e., it is possible to bond further adhesive seams using commercially available hot melt adhesives. Similarly, if applicable, non-fragrant hot melt adhesives of this kind can be applied concurrently with the fragrance-containing adhesive surfaces. Exposed surfaces of the adhesively bonded surfaces of an adhesive according to the present invention can thereby be shielded from the environment. Fragrance loss during storage can thereby be diminished.

A subject of the invention is the use of fragrance-containing hot melt adhesives in the packaging of articles, and release of the fragrances when the package is torn open. When the hot melt adhesives according to the present invention are used to adhesively bond packages, they are utilized in accordance with the known application methods. The hot melt adhesive according to the present invention is covered on both sides by a substrate, and joins them. This adhesively bonded surface is to be arranged in such a way that the adhesive seam is at least partly exposed when the package is torn open. When the package is torn open or when an adhesively bonded reclosable package is opened, a cohesive break occurs in the hot melt adhesive, or an adhesive break is obtained between the substrate surface and the hot melt adhesive. This tearing-open operation produces a large surface area of open hot melt adhesive. From this surface, the fragrance present according to the present invention in the hot melt adhesive can be released and can immediately form a corresponding fragrance cloud. If small concentrations of water are containing in the hot melt adhesive, they can result in decreased adhesion or cohesion. The exposure of an adhesively bonded surface is thereby facilitated. In addition, any water that may be contained can evaporate and release the fragrances in enhanced fashion. Breakage of the adhesively bonded surface can thus result in a release of the fragrances contained therein. It is also possible to adhesively bond packages for foods that are stored at low temperature. A corresponding odor can be released upon opening of the package in the cold state.

The hot melt adhesives according to the present invention comprise only small concentrations of the fragrances. They are intended substantially to release a fragrance cloud only briefly upon opening of the corresponding package. Said cloud is intended to dissipate again after a short time. It is also possible, by selecting fragrances that volatilize slowly, to release a fragrance cloud repeatedly in the context of packages that are reclosable more than once.

In a further embodiment, in the context of packaging of insensitive products it is also possible to apply, inside the package, an application surface having a hot melt adhesive containing fragrances according to the present invention. The package is then adhesively bonded with usual hot melt adhesives. It is thereby possible to produce a fragrance cloud inside the package. When the package is torn open for the first time, or reopened when a reclosable cover is present, a release of an odor cloud from the package volume occurs. The corresponding product, e.g., a washing agent, can be removed, and another fragrance cloud builds up again inside the package after it is closed. A correspondingly configured package is suitable for goods that are not completely used up, and are not negatively influenced by contact with the fragrance cloud.

In a further embodiment, the hot melt adhesive according to the present invention is covered by an additional layer; the hot melt adhesive can also be applied externally onto the package and then provided with a cover layer, for example a cover film. It is also possible, however, to equip this cover film with a (for example, contact-adhesive) hot melt adhesive and apply it onto the package in the form of a label. If the fragrance note of the adhesive that is used corresponds to the inherent odor of the packaged product, it is thus possible, without opening the package, to convey a corresponding odor impression to the customer. With a suitable selection of the hot melt adhesives, the adhesively bonded surfaces releasing the fragrance can be reclosed, and upon repeated removal the fragrance is released again each time.

In any event, a fragrance effect on the part of the adhesively bonded or applied hot melt adhesive exists even after extended storage. Very little migration of the odor compounds through the surface of the substrates occurs, so that an odor effect exists to a sufficient extent even after extended storage. If applicable, a suitable substrate surface can be selected that decreases diffusion into or through the substrate.

By selecting the adhesive for a product, it is possible to select the fragrance component appropriate for the product. The adhesive according to the present invention is applied, in this context, in such a way that it releases the fragrance when the package is opened. It can also, however, be applied onto an exposed side of the package and be provided with an additional cover layer.

For foods, for example, it is important to ensure that fragrances are selected which are not deleterious to the packaged product and are kept away from the product by one side of a substrate itself, e.g., by a film; an outer package can also be bonded using the adhesive according to the present invention. In the context of applications for cosmetic articles or consumer goods, for example washing agents, care must be taken that no health hazards, for example allergic reactions, are caused by the fragrance.

It is also possible, with an application of a hot melt adhesive containing a fragrance, to provide objects with olfactory marks. The fragrance is then not matched to the product, but is instead intended to provide a recognizable indication as a mark. The compositions and usual application methods described above can be utilized in this case as well.

The procedure according to the present invention makes possible adhesive bonding of, for example, food or consumer-goods packages that impart to the consumer, upon opening, a pleasant odor or one typical of food. It is additionally possible, for example, to adhesively bond cosmetics packages with hot melt adhesives of this kind according to the present invention. Here a fragrance matched to the intended application can be added to the hot melt adhesive. The hot melt adhesive according to the present invention is used in particular for adhesive bonding of packages in the consumer-goods industry, food industry, or cosmetics industry.

By selecting fragrances having appropriate c Log P values, it is possible to ensure that the fragrance can be incorporated in stable fashion into the hot melt adhesive, and that migration into the substrate surface is decreased. “Sweating out” onto the surface of the adhesive bead is decreased, and adhesion to the substrate is thus not negatively influenced. The manufacturing procedure according to the present invention makes possible easy manufacture of the products, precluding or diminishing possible emissions during incorporation and handling of the fragrance components. Continuous manufacture using an extruder enables lower processing temperatures and faster homogenization with shorter residence times. The adhesive components, and in particular the fragrances, are therefore exposed to only minor temperature stresses, so that the compounds are not thermally destroyed or experience only minor stress. Packages manufactured and adhesively bonded according to the present invention have only small exposed surfaces facing outward, thus preventing premature distribution of the fragrance cloud in storage. Additionally, in the case of reclosable packages in particular, no fragrance components can diffuse into the environment in the reclosed state. Upon exposure of a large surface area, the fragrance present according to the present invention is released. Selection of the fragrances allows the fragrance and aroma cloud to be matched and allocated to specifically packaged products.

The Examples below present procedures according to the present invention.

| Fragrance mixture D1 | | | cLogP |
|---|---|---|---|
| 3 | parts | Musk anthranilate | 2.2 |
| 10 | parts | Heliotropin | 1.65 |
| 4 | parts | Anisaldehyde | 1.67 |
| 6 | parts | Dihydro-β-ionone | 4.48 |
| 11 | parts | Aldehyde C09 (10%) | 3.27 |
| 12 | parts | Octalactone delta | 1.59 |
| 9 | parts | Ethyl vanillin | 1.55 |
| 13 | parts | Ethyl maltol | 1.59 |
| 5 | parts | Linalool | 2.85 |
| 8 | parts | Patchouli 83-2970 | 2.0 |
| 7 | parts | Vanillin | 1.4 |

made up to a total of 100 parts with dipropylene glycol

Fragrance mixture D2

| | | |
|---|---|---|
| 30 parts | Vanilla Dream | 1.7 |
| 22 parts | Ethyl vanillin | 1.55 |
| 10 parts | Siam benzoin | 1.2 |
| 10 parts | Vanillin | 1.4 |

made up to a total of 100 parts with dipropylene glycol

Fragrance mixture D3

| | |
|---|---|
| 0.2 parts | Fragrance mixture 2 |
| 0.5 parts | PLANTACARE 1200 (APG) |
| 5.3 parts | Water |

Mix in dissolver to form a stable emulsion.

Hot melt adhesive M1

| | | | |
|---|---|---|---|
| 50 | parts | Ethylene/1-octene copolymer | AFFINITYGA1900 |
| 20 | parts | Hydrocarbon resin (tackifier) | ARKON M100 |
| 10 | parts | Paraffin wax | PARAFLINT H1 |
| 19.8 | parts | Paraffin wax | Sasol Wax 6703 |

Hot melt adhesive M2

| | | | |
|---|---|---|---|
| 60 | parts | Propylene/ethylene copolymer | LICOCENE 1602 |
| 19.8 | parts | Hydrocarbon resin | ARKON M100 |
| 10 | parts | Paraffin wax | PARAFLINT H1 |
| 10 | parts | Polyisobutylene | INDOPOL H-300 |
| 0.1 | parts | Stabilizer | IRGANOX 1010 |

### Example 1

The olefin copolymer and tackifying resin according to M1 are introduced into a double-screw extruder (Brabender) and melted and mixed while being heated. The two paraffin waxes are then metered in and homogenized in the extruder. The temperature is set to 130° C., and 0.1 parts D1 are then added and incorporated. The mixture is degassed, cooled to 120° C., and discharged from the extruder.

The adhesive is poured into molds lined with silicone paper, and cooled. The result is a hot melt adhesive that is solid at room temperature.

### Example 2

The hot melt adhesive according to M1 is produced. It is then introduced at room temperature into a double-screw extruder together with 0.2 parts D2, mixed, and melted. The mixture is degassed, adjusted to approx. 60° C., and discharged from the extruder.

The adhesive is discharged as a strand, cooled with air, and then pelletized. The result is a hot melt adhesive that is solid at room temperature.

### Example 3

The hot melt adhesive according to M2 is produced. It is then heated and, at 80° C., introduced into a double-screw extruder and homogenized. 5 parts D3 are added at approx. 80-90° C. and mixed. The mixture is discharged from the extruder.

The adhesive is discharged as a strand, cooled with air, and then pelletized. The result is a hot melt adhesive that is solid at room temperature.

### Example 4

The copolymer and hydrocarbon resin according to M2 are introduced into a double-screw extruder (Brabender) and melted and mixed while being heated. The paraffin wax, plasticizer, and additive are then metered in and homogenized in the extruder. 0.5 parts D2 are then added and incorporated. The mixture is discharged from the extruder at 100° C.

The adhesive is poured into molds lined with silicone paper, and cooled. The result is a hot melt adhesive that is solid at room temperature.

### Example 5

The mixture of individual binder components according to M2 is introduced into a double-screw extruder (Brabender), mixed, and melted. The stabilizer is then metered in, and D2 is added as a premix, in a quantity of 0.1 parts with 0.5 parts ethanol, and homogenized. The temperature is held at approx. 70° C., and the mixture is degassed and discharged from the extruder.

The adhesive is poured into molds lined with silicone paper, and cooled. The result is a hot melt adhesive that is solid at room temperature.

### Adhesive Bonding+Test 1

Two paper substrates are adhesively bonded using each of the hot melt adhesives according to Examples 1 to 5, the bonded surface area being approx. 2 cm² in size. The odor of the bonded substrate is almost or entirely imperceptible.

After 24 hours, the adhesively bonded area is torn open. An exposed adhesive surface is produced that immediately propagates a fragrance cloud.

Polyethylene films, PET films, polypropylene films, metallized polyethylene films, metallized paper, and paperboard are bonded analogously. Almost no fragrance is perceptible. A readily perceptible fragrance cloud occurs when the adhesive bond is torn open at room temperature.

### Adhesive Bonding+Test 2

Two PET-film substrates are adhesively bonded using the hot melt adhesive according to Example 2, the bonded surface area being approx. 2 cm² in size. The odor of the bonded substrate is almost or entirely imperceptible. The bonded substrates are stored at 0° C.

After 24 hours, the adhesively bonded area is torn open. An exposed adhesive surface is produced that immediately propagates a fragrance cloud.

What is claimed is:

1. A hot melt adhesive for adhesively bonding packaging material, comprising:
a) 10 to 75 wt % of at least one adhesive base polymer;
b) 10 to 70 wt % of at least one tackifying resin;
c) 0 to 50 wt % of at least one wax and/or plasticizer;
d) 0 to 15 wt % of at least one additive;
e) 0.01 to 10 wt % of at least one fragrance having a c Log P value between 1.0 and 20;
the sum equaling 100%.

2. The hot melt adhesive according to claim 1, wherein the adhesive base polymer is selected from the group consisting of polyolefin (co)polymers, ethylene-vinyl acetate (co)polymers, polyurethanes, polyesters, and polyamides.

3. The hot melt adhesive according to claim 1, having a viscosity between 100 and 15,000 mPas at 120 to 180° C., and wherein the base polymer has a molecular weight from 2000 to 200,000 g/mol.

4. The hot melt adhesive according to claim 1, wherein the fragrance has a c Log P value between 1.2 and 10, and a molecular weight less than 300 g/mol.

5. The hot melt adhesive according to claim 1, wherein the fragrance is selected from the group consisting of aromatic and aliphatic esters, aromatic and aliphatic alcohols, aromatic and aliphatic ketones, aromatic and aliphatic aldehydes, and aliphatic and aromatic ethers.

6. The hot melt adhesive according to claim 1, comprising:
a) 10 to 65 wt % of at least one linear copolymer of ethylene and/or propylene with, optionally, at least one C₄ to C₂₀ α-olefin comonomer, wherein the linear copolymer
i) has an Mₙ from 2000 to 100,000; and
ii) a density between 0.85 and 0.96 g/cm³;
b) 10 to 50 wt % of at least one tackifying resin;
c) 0 to 30 wt % of at least one plasticizer and/or wax;
d) 0 to 15 wt % of at least one additive; and
e) 0.05 to 5 wt % of at least one fragrance that exhibits predominantly a middle and/or base note.

7. The hot melt adhesive according to claim 6, wherein the linear copolymer is made of propylene with at least one further C₂ or C₄ to C₂₀ α-olefin, and is manufactured by metallocene catalysis.

8. The hot melt adhesive according to claim 7, wherein the linear copolymer has a molecular weight from 3000 to 25,000 g/mol and a dispersity index M_{W}:M_{N} less than 3.

9. A method for continuous manufacture of a hot melt adhesive according to claim 1, wherein:
a) in a first step, the hot melt adhesive or adhesive components used to form the hot melt adhesive are mixed and melted in an extruder to form a melt, the temperature of the melt being kept below 180° C.;
b) in a further step, at least one liquid or solid fragrance is added to the melt and homogenized in said extruder; and
c) the melt is cooled and packaged.

10. The method according to claim 9, wherein:
a) in a first step, the base polymer and the tackifying resin are mixed to form a first mixture;
b) if applicable, in a second step or in further steps, the plasticizer, wax, and additive are added to the first mixture and homogenized to form a second mixture, the second mixture being held at a temperature below 180° C.;
c) in a final stage, the fragrance is incorporated in the first mixture or second mixture to form a product, the fragrance being added alone, as a mixture with a portion of a component of the hot melt adhesive, or mixed with a solvent; and
d) the product is cooled and packaged.

11. The method according to claim 10, wherein the temperature of the first mixture or second mixture in the extruder prior to addition of the fragrance is below 120° C.

12. The method according to claim 10, wherein the fragrance is incorporated into a homogeneous mixture with a portion of a plasticizer or a wax prior to incorporating the fragrance in the second mixture.

13. The method according to claim 10, wherein the fragrance is incorporated in an aqueous solution or emulsion, or dissolved in at least one organic solvent prior to incorporating the fragrance in the first mixture or second mixture.

14. The method according to claim 13, wherein the pressure in the extruder during homogenization is sufficiently high that no vapor bubbles occur at processing temperature.

15. The method according to claim 9, wherein addition of the fragrance is carried out in a system encapsulated from the environment, so that only small quantities of the fragrance escape into the environment.

16. The method according to claim 9, wherein the extruder is a double-screw extruder.

17. A method of manufacturing a package using an adhesive, said method comprising using a hot melt adhesive according to claim 1 as the adhesive.

18. The method according to claim 17, wherein upon opening of the package an adhesively bonded surface is exposed, and the fragrance is thereby released.

19. The method according to claim 18, wherein the package is reclosable at the adhesively bonded surface.

20. The method according to claim 18, wherein an adhesive without fragrance is additionally used.

21. The method according to claim 17, wherein the hot melt adhesive is applied on an outer side of the package and is adhesively bonded to a cover layer.

22. The method according to claim 17, wherein the hot melt adhesive is applied on an inner surface of the package.

23. The method according to claim 17, wherein said package is to be used in the consumer-goods, food, or cosmetics industry.

24. The method according to claim 17, wherein said package is to be used for goods that are stored at low temperature.
